(19) United States
(12) Patent Application Publication
(10) Pub. No.: US 2015/0074503 A1
(43) Pub. Date: Mar. 12, 2015

(54) CHARACTER STRING PLACEMENT AND DRAWING DEVICE

(71) Applicant: Ken Miyamoto, Tokyo (JP)

(72) Inventor: Ken Miyamoto, Tokyo (JP)

(73) Assignee: Mitsubishi Electric Corporation, Tokyo (JP)

(21) Appl. No.: 14/386,210

(22) PCT Filed: Jun. 14, 2012
(86) PCT No.: PCT/JP12/65245

§ 371 Date: Sep. 18, 2014

(51) Int. Cl. G06F 17/24

(52) U.S. Cl. CPC G06F 17/24
USPC 715/202

(57) ABSTRACT

A character string placement and drawing device includes: a character string placer that places a character string from each of placement candidate points of the character string along a road node series; an evaluation function calculator that calculates evaluation function values for evaluating readability of the character string from a gap between the character string and another character string which are placed by the character placer; and a character string drawing unit that draws the character string by using the evaluation function values.

### FIELD OF THE INVENTION

The present invention relates to a character string placement and drawing device that dynamically places character strings, such as road names, on a map.

### BACKGROUND OF THE INVENTION

Conventionally, a map display device having a character string placement function of placing a character string, such as a road name, from a point (referred to as a “character string placement start point” from here) at which the placement of the character string is started along a road line (referred to as a “road node series” from here on) is known.

In this map display device, when the character string placement start point is not appropriate, there are problems as follows:

(1) an overlap between character strings;

(2) a reduction in the readability due to a change of the display angles of characters;

(3) a reduction in the readability due to the crowding of character strings; and

(4) a partial disappearance of a character string due to a change of a display area.

In order to solve the above-mentioned problems (1) and (2), nonpatent reference 1 discloses a technique of changing the character string placement start point to a position where the readability is high. According to this technique, an optimal character string placement start point is determined by minimizing the value of an evaluation function which consists of a function showing an overlap between the character string and another character string and a function showing an angle variation of the road node series along which the character string is placed.

Further, in order to solve the above-mentioned problem (3), patent reference 1 discloses a technique of dynamically changing the position of the character string according to a change of the display area.

### RELATED ART DOCUMENT

### Patent Reference

Patent reference 1: Japanese Unexamined Patent Application Publication No. 2005-77428

### Nonpatent Reference

Nonpatent reference 1: Shawn Edmondson, “A General Cartographic Labeling Algorithm”, The International Journal for Geographic Information and Geovisualization, Volume 33, Number 4/Winter 1996

### SUMMARY OF THE INVENTION

### Problems to be Solved by the Invention

Although the above-mentioned problems (1) and (2) can be solved by using the technique disclosed by nonpatent reference 1, the above-mentioned problem (3), i.e., a reduction in the readability due to the crowding of character strings cannot be avoided. Further, because according to the technique disclosed by patent reference 1 the placement position of the character string is not necessarily determined in consideration of the above-mentioned problems (1) to (3), the occurrence of these problems cannot be avoided.

Although the techniques of avoiding some of the above-mentioned problems (1) to (4) are known, as mentioned above, all of the problems (1) to (4) cannot be avoided simultaneously.

The present invention is made in order to avoid all of the problems (1) to (4), and it is therefore an object of the present invention to provide a character string placement and drawing device that can place a character string at an optimal position in consideration of not only an overlap with another character string and an angle variation of a road along which the character string is placed, but also the degree of crowding of character strings and a relationship between the character string and a display area.

### Means for Solving the Problem

In accordance with the present invention, there is provided a character string placement and drawing device including a character string data storage that stores character string data including the number of character strings, a road node series along which each character string is to be placed, and placement candidate points of each character string; a character string data acquiring unit that acquires character string data from the character string data storage; a processing target character string specifier that specifies a character string which is a processing target from the character string data acquired by the character string data acquiring unit; a candidate point acquiring unit that acquires placement candidate points from the character string data acquired by the character string data acquiring unit; a processing target candidate point specifier that specifies placement candidate points each of which is a processing target from among the placement candidate points acquired by the candidate point acquiring unit; a character string placer that places the character string sent thereto from the processing target character string specifier from each of the placement candidate points sent thereto from the processing target candidate point specifier along a road node series included in the character string data sent thereto from the character string data acquiring unit; an evaluation function calculator that calculates evaluation function values for evaluating the character string placed by the character string placer; a minimum evaluation function value storer that stores an evaluation function value which is a minimum of the evaluation function values calculated by the evaluation function calculator, and a placement of the character string corresponding to this evaluation function value; and a character string drawing unit that draws the character string having the placement stored in the minimum evaluation function value storer.

### Advantages of the Invention

The character string placement and drawing device in accordance with the present invention can place a character string at an optimal position in consideration of not only an overlap with another character string and an angle variation of a road along which the character string is to be placed, but also the degree of crowding of character strings and a relationship between the character string and the display area.

### BRIEF DESCRIPTION OF THE FIGURES

FIG. 1 is a block diagram showing the structure of a character string placement and drawing device in accordance with Embodiment 1 of the present invention;

FIG. 2 is a flow chart showing the operation of the character string placement and drawing device in accordance with Embodiment 1 of the present invention;

FIG. 3 is a view showing a relationship among road node series, placement candidate points, and a display area at a time t+α, which is used by the character string placement and drawing device in accordance with Embodiment 1 of the present invention;

FIG. 4 is a view showing a relationship among the display area at a time t, the road node series, and character strings, which is used by the character string placement and drawing device in accordance with Embodiment 1 of the present invention;

FIG. 5 is a view showing a relationship between the display area at the time t+α and the character strings, which is used by the character string placement and drawing device in accordance with Embodiment 1 of the present invention;

FIG. 6 is a view showing a state in which a character string is placed from a placement candidate point C(2) along a road node series in the character string placement and drawing device in accordance with Embodiment 1 of the present invention;

FIG. 7 is a flow chart showing the details of an evaluation function process performed in step ST19 of FIG. 2;

FIG. 8 is a view showing an example of the distribution of a character string gap function value in the character string placement and drawing device in accordance with Embodiment 1 of the present invention;

FIG. 9 is a view showing an example of the distribution of a road angle function value in the character string placement and drawing device in accordance with Embodiment 1 of the present invention;

FIG. 10 is a view showing an example of the distribution of a display area function value in the character string placement and drawing device in accordance with Embodiment 1 of the present invention;

FIG. 11 is a view showing an example in which the character string is placed from a placement candidate point C(3) in the character string placement and drawing device in accordance with Embodiment 1 of the present invention;

FIG. 12 is a view showing an example in which the character string is placed from a placement candidate point C(4) in the character string placement and drawing device in accordance with Embodiment 1 of the present invention;

FIG. 13 is a view showing an example in which the character string is placed from a placement candidate point C(5) in the character string placement and drawing device in accordance with Embodiment 1 of the present invention;

FIG. 14 is a view showing a correspondence between the character string which is placed from each placement candidate point and the evaluation function value in the character string placement and drawing device in accordance with Embodiment 1 of the present invention;

FIG. 15 is a view for explaining a function, which a typical character string placement and drawing device has, of placing a character string, such as a road name, from a character string placement start point along a road line;

FIG. 16 is a view for explaining an overlap between character strings which occurs in a typical general character string placement and drawing device;

FIG. 17 is a view for explaining a reduction in readability due to a change of the display angles of characters which occurs in a typical character string placement and drawing device;

FIG. 18 is a view for explaining a reduction in the readability due to the crowding of character strings which occurs in a typical character string placement and drawing device;

FIG. 19 is a view for explaining a partial disappearance of a character string due to a change of the display area which occurs in a typical character string placement and drawing device;

FIG. 20 is a view for explaining a function disclosed by nonpatent reference 1 and showing an overlap between character strings;

FIG. 21 is a view for explaining a function disclosed by nonpatent reference 1 and showing an angle variation in a road node series along which a character string is placed; and

FIG. 22 is a view showing an example in which the placement position of a character string is changed by using a technique disclosed by patent reference 1.

### EMBODIMENTS OF THE INVENTION

Hereafter, the preferred embodiments of the present invention will be explained in detail with reference to the drawings.

### Embodiment 1

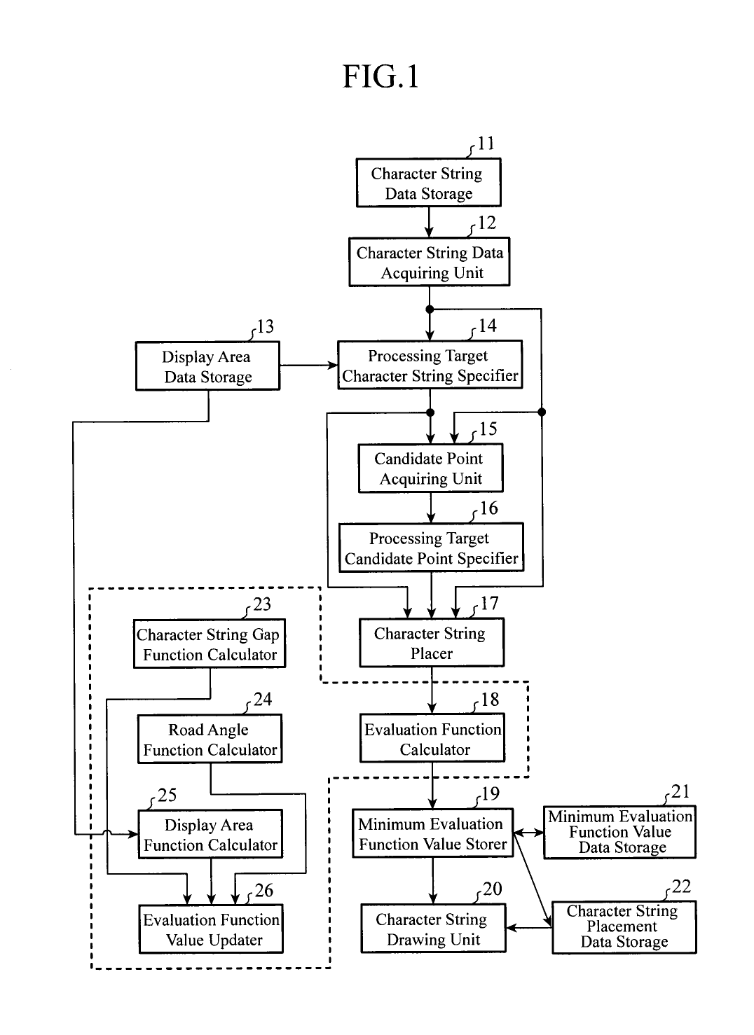

FIG. 1 is a block diagram showing the structure of a character string placement and drawing device in accordance with Embodiment 1 of the present invention. This character string placement and drawing device includes a character string data storage 11, a character string data acquiring unit 12, a display area data storage 13, a processing target character string specifier 14, a candidate point acquiring unit 15, a processing target candidate point specifier 16, a character string placer 17, an evaluation function calculator 18, a minimum evaluation function value storer 19, a character string drawing unit 20, a minimum evaluation function value data storage 21, and a character string placement data storage 22.

The character string data storage 11 stores character string data. Character string data include the number of character strings, the number of characters of each character string, the lateral width and the longitudinal width of each character, a road node series along which each character string is to be placed, and placement candidate points of each character string.

The character string data acquiring unit 12 acquires character string data from the character string data storage 11. The character string data acquired by this character string data acquiring unit 12 are sent to the processing target character string specifier 14, the candidate point acquiring unit 15, and the character string placer 17.

The display area data storage 13 stores a region in which character strings are to be displayed as display area data. The display area data stored by this display area data storage 13 are read by the display area function calculator 25 (which will be mentioned below in detail) which constructs the processing target character string specifier 14 and the evaluation function calculator 18.

The processing target character string specifier 14 selects and specifies a character string whose placement position needs to be changed from a relationship between the character strings included in the character string data sent thereto from the character string data acquiring unit 12 and the display area shown by the display area data read from the display area data storage 13. The character string specified by this processing target character string specifier 14 is sent to the candidate point acquiring unit 15 and the character string placer 17 as a processing target character string. A reduction in the processing load can be achieved by the selection of a character string by this processing target character string specifier 14.

The candidate point acquiring unit 15 acquires the placement candidate points of the processing target character string (the character string which is a target for process of changing the placement position) sent thereto from the processing target character string specifier 14 from among the placement candidate points included in the character string data sent thereto from the character string data acquiring unit 12. The placement candidate points acquired by this candidate point acquiring unit 15 are sent to the processing target candidate point specifier 16.

The processing target candidate point specifier 16 selects and specifies placement candidate points each of which is a processing target from among the placement candidate points sent thereto from the candidate point acquiring unit 15, concretely, placement candidate points included in the display area. The placement candidate points specified by this processing target candidate point specifier 16 are sent to the character string placer 17. A reduction in the processing load can be achieved by the selection of placement candidate points by this processing target candidate point specifier 16.

The character string placer 17 places the processing target character string sent thereto from the processing target character string specifier 14 from each of the placement candidate points sent thereto from the processing target candidate point specifier 16 along the road node series included in the character string data sent thereto from the character string data acquiring unit 12. The character string placed by this character string placer 17 is sent to the evaluation function calculator 18.

The evaluation function calculator 18 calculates an evaluation function for evaluating the readability of the character string which is sent thereto from the character string placer 17 and which is placed. The evaluation function calculated by this evaluation function calculator 18 is sent to the minimum evaluation function value storer 19.

Hereafter, the evaluation function calculator 18 will be explained in detail. The evaluation function calculator 18 includes a character string gap function calculator 23, a road angle function calculator 24, a display area function calculator 25, and an evaluation function value updater 26.

The character string gap function calculator 23 calculates a function value (referred to as a “character string gap function value” from here on) for evaluating the readability of the character string from the gap between the character string and another character string which are sent thereto from the character string placer 17. The character string gap function value calculated by this character string gap function calculator 23 is sent to the evaluation function value updater 26.

The road angle function calculator 24 calculates a function value (referred to as a “road angle function value” from here on) for evaluating an angle variation of the road along which the character string sent thereto from the character string placer 17 is to be placed. The road angle function value calculated by this road angle function calculator 24 is sent to the evaluation function value updater 26.

The display area function calculator 25 calculates a function value (referred to as a “display area function value” from here on) for evaluating a relationship between the display area shown by the display area data read from the display area data storage 13 and the character string sent thereto from the character string placer 17. The display area function value calculated by this display area function calculator 25 is sent to the evaluation function value updater 26.

The evaluation function value updater 26 updates the evaluation function value by using the character string gap function value sent thereto from the character string gap function calculator 23, the road angle function value sent thereto from the road angle function calculator 24, and the display area function value sent thereto from the display area function calculator 25. The evaluation function value updated by this evaluation function value updater 26 is sent to the minimum evaluation function value storer 19.

The minimum evaluation function value storer 19 stores the minimum of the evaluation function values sent thereto from the evaluation function calculator 18 in the minimum evaluation function value data storage 21. Concretely, the minimum evaluation function value storer 19 stores a character string gap function value which makes it possible to avoid an overlap between the character string and another character string, and improve the readability of the character string, from among the character string gap function values calculated by the character string gap function calculator 23, stores a minimum road angle function value which avoids the placement of the character string along a road which is not flat, from among the road angle function values calculated by the road angle function calculator 24, and stores a display area function value which avoids the placement of the character string outside the display area, from among the display area function values calculated by the display area function calculator 25. Further, the minimum evaluation function value storer 19 stores the placement of the character string corresponding to the evaluation function value stored in the minimum evaluation function value data storage 21, i.e., the placement of the character string at the time when the minimum evaluation function value is calculated in the character string placement data storage 22.

When the minimum evaluation function value storer 19 stores the evaluation function value and the placement of the character string, the character string drawing unit 20 reads the character string from the character string placement data storage 22 and draws the character string.

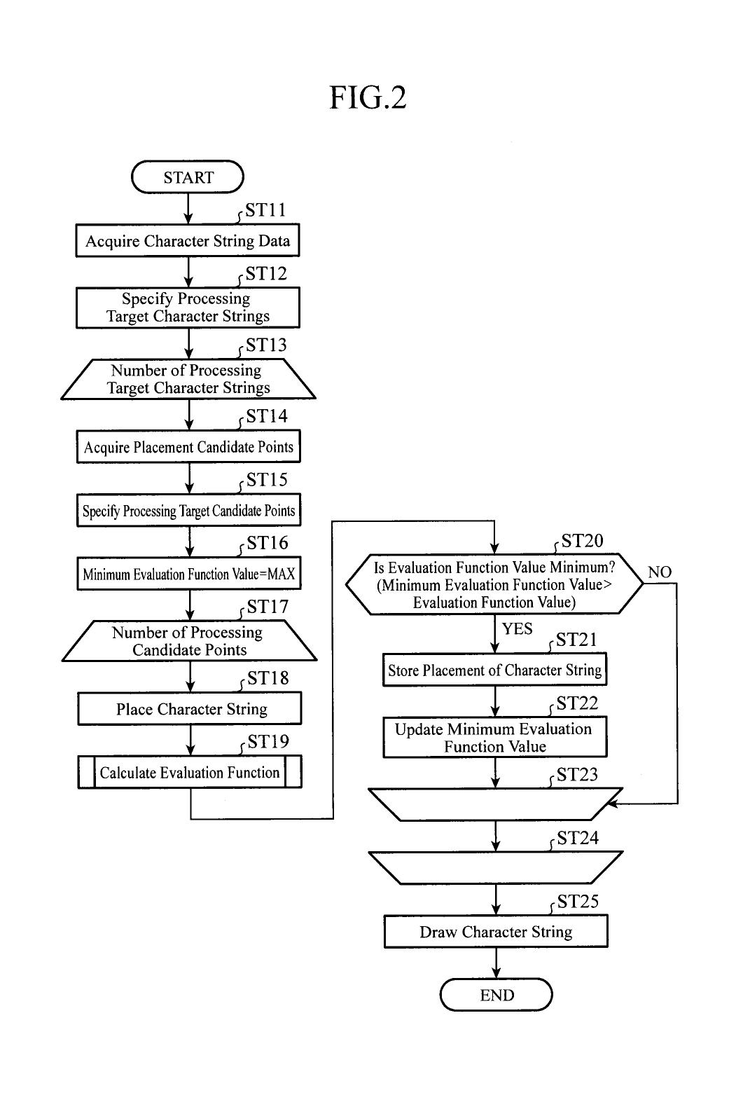

Next, the operation of the character string placement and drawing device in accordance with Embodiment 1 constructed as above will be explained. FIG. 2 is a flow chart showing the operation of the character string placement and drawing device. Although the processing shown in this FIG. 2 can be performed at predetermined time intervals or on a per frame basis, it is assumed hereafter that the processing is carried out at time intervals of a fixed time length α, and the time when the processing was performed the last time is t.

It is assumed hereafter that the character string data include a character string “GOOD” and a character string “NEED”, the lateral width and the longitudinal width of each character are 10 and 20, respectively, a road node series along which the character string “GOOD” is to be placed consists of P(1)=(100, −20), P(2)=(100, 125), and P(3)=(220, 125), and a road node series along which the character string “NEED” is to be placed consists of P(4)=(0, 75) and P(5)=(200, 75).

Further, it is assumed that a parameter ROAD_ANGLE_COVARIANCE for calculation of an evaluation function (abbreviated as “RC” from here on) is given by the following equation (1), a parameter LABEL_{—} OVERLAP_{—} COVARIANCE (abbreviated as “LC” from here on) for calculation of an evaluation function is given by the following equation (2), a parameter ROAD_ANGLE_SCALE (abbreviated as “RS” from here on) for calculation of an evaluation function is “1”, a parameter LABEL_OVERLAP_SCALE (abbreviated as “LS” from here on) for calculation of an evaluation function is “1”, a parameter DISPLAY_AREA_SCALE (abbreviated as “DS” from here on) for calculation of an evaluation function is “4”, and a parameter DISPLAY_AREA_FUNCTION_SCALE (abbreviated as “DFS” from here on) for calculation of an evaluation function is “0.1.”

$$\begin{matrix}ROAD\_ANGLE \_COVARIANCE = ( \begin{matrix}50 & 0 \\ 0 & 50\end{matrix} ) & ( 1 ) \\ LABEL\_OVERLAP \_COVARIANCE = ( \begin{matrix}50 & 0 \\ 0 & 50\end{matrix} ) & ( 2 )\end{matrix}$$

Further, it is assumed that a display area at the time t is defined by Rt(1)=(0, −20), Rt(2)=(200, −20), Rt(3)=(200, 180), and Rt(4)=(0, 180), and the display area at the time t+α when only the fixed time period a has elapsed since the time t is defined by Rt+α(1)=(0, 0), Rt+α(2)=(200, 0), Rt+α(3)=(200, 200), and Rt+α(4)=(0, 200).

Further, it is assumed that the placement candidate points of the character string “GOOD” are C(1)=(100, −20), C(2)=(100, 60), C(3)=(100, 115), C(4)=(120, 125), and C(5)=(180, 125).

Further, it is assumed that the placement of the character string “GOOD” at the time t is defined by Lt(1)=(100, −20), Lt(2)=(100, −10), Lt(3)=(100, 0), and Lt(4)=(100, 10). Lt(1), Lt (2), Lt (3), and Lt (4) show the left bottom coordinates of the characters “G”, “O”, “O”, and “D” which construct the character string “GOOD”, respectively, and the characters are placed along the road.

It is similarly assumed that the placement of the character string “NEED” at the time t is defined by Lt(5)=(80, 75), Lt(6)=(90, 75), Lt(7)=(100, 75), and Lt(8)=(110, 75). Lt (5), Lt (6), Lt (7), and Lt (8) show the left bottom coordinates of the characters “N”, “E”, “E”, and “D” which construct the character string “NEED”, respectively, and the characters are placed along the road.

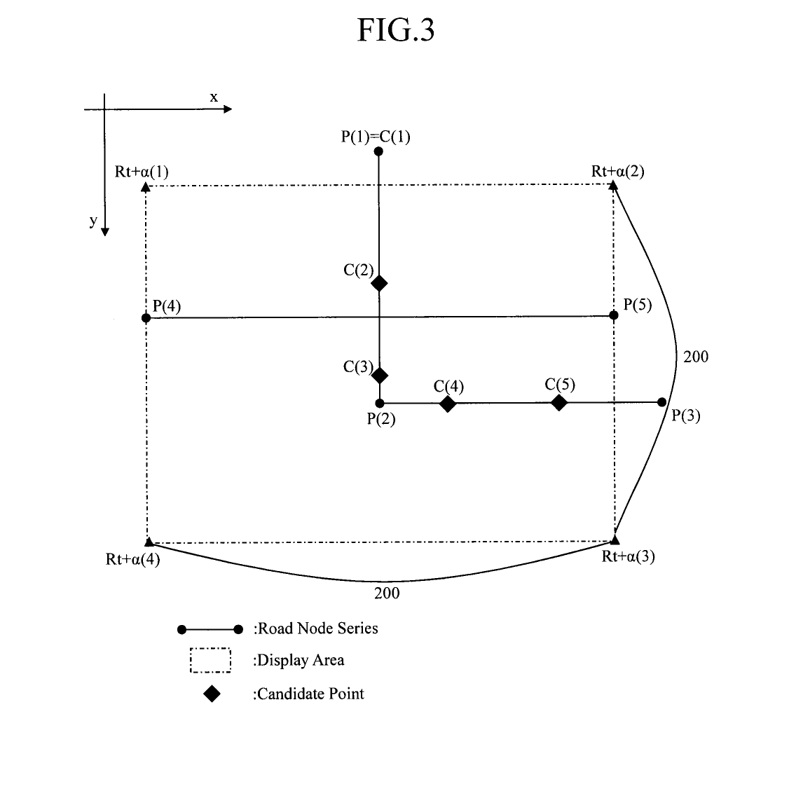

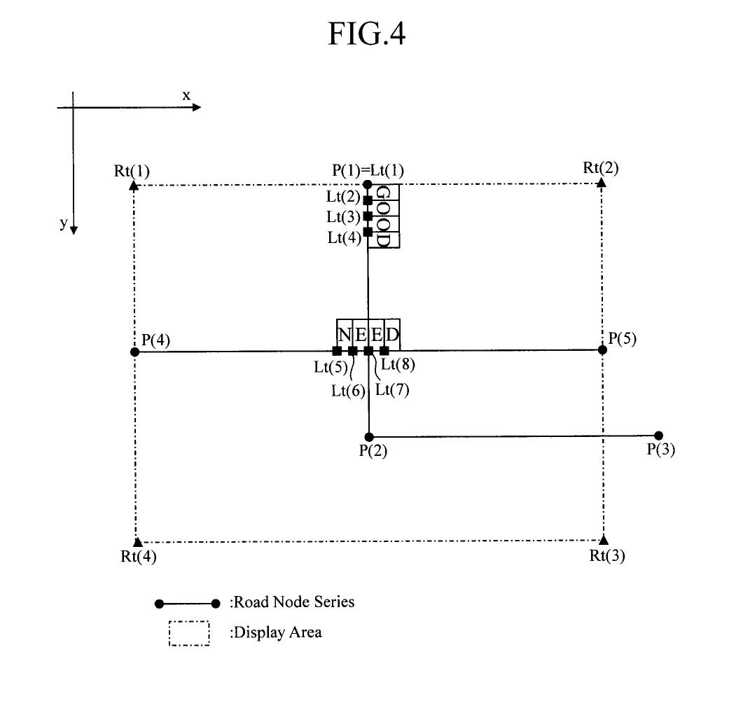

FIG. 3 shows a relationship among the road node series P(1) to P(3), and the placement candidate points C(1) to C(5) of the character string “GOOD”, and the display area at the time t+α. Further, FIG. 4 shows a relationship among the display area at the time t, the road node series P(1) to P(3), and the character string “GOOD”.

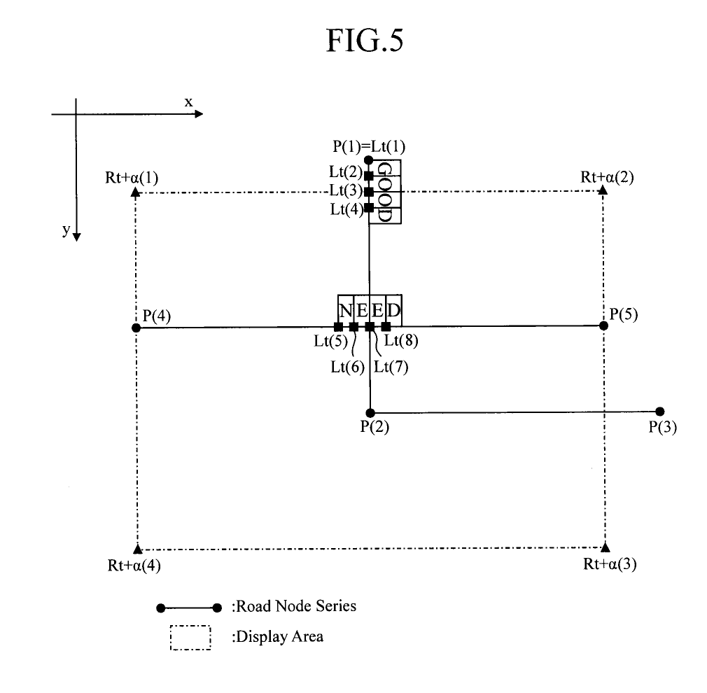

In this character string placement and drawing device, when the time t+α comes, the processing shown in the flowchart of FIG. 2 is started. At the time t+a, the display area Rt(1) to Rt(4) at the time t changes to the display area Rt+α(1) to Rt+α(4). FIG. 5 shows a relationship between the display area Rt+α(1) to Rt+α(4) at the time t+α and the character strings. The placement position of each of the character strings shown in FIG. 5 is the one determined before the processing shown in the flow chart of FIG. 2 is carried out.

When the processing is started, the character string data are acquired first (step ST11). More specifically, the character string data acquiring unit 12 acquires the character string data from the character string data storage 11. In this case, the character string “GOOD”, the character string“NEED”, the placement candidate points associated with the placement of each of these character strings, and the road node series are acquired. These acquired character string data are sent to the processing target character string specifier 14, the candidate point acquiring unit 15, and the character string placer 17.

A processing target character string is then specified (step ST12). More specifically, the processing target character string specifier 14 specifies a character string whose placement position is to be changed from a relationship between the character strings included in the character string data sent thereto from the character string data acquiring unit 12 and the display area shown by the display area data read from the display area data storage 13. Concretely, the processing target character string specifier 14 specifies a character string which satisfies a condition shown below.

<Condition 1> a character string which could not be placed at the time t, but can be placed in the display area when the time t+α comes.
<Condition 2> a character string part or all of which exists outside the display area.

In the case of the example shown in FIG. 5, only the character string “GOOD”, among the character strings “GOOD” and “NEED”, satisfies one of the above-mentioned conditions. More specifically, the character string “GOOD” satisfies the condition 2 because the first and second characters exist outside the display area at the time t+a.

When a processing target character string is specified, processes between steps ST13 and ST24 are repeatedly performed the number of times corresponding to the number of processing target character strings, and the placement position of the specified character string is changed.

In these repeatedly-performed processes, the placement candidate points are acquired first (step ST14). More specifically, the candidate point acquiring unit 15 acquires the placement candidate points of a processing target character string sent thereto from the processing target character string specifier 14 (a character string which is a target for the processes of changing the placement position) from among the placement candidate points included in the character string data acquired by the character string data acquiring unit 12 in step ST11. In the case of the example shown in FIG. 5, the placement candidate points C(1) to C(5) of the character string “GOOD” (refer to FIG. 3) are acquired.

A processing target candidate point is then specified (step ST15). More specifically, the processing target candidate point specifier 16 specifies a placement candidate point from among the placement candidate points sent thereto from the candidate point acquiring unit 15, and sends this specified placement candidate point to the character string placer 17. Concretely, the above-mentioned specification of a placement candidate point can be performed by determining whether a placement candidate point satisfies the following condition 3.

<Condition 3> a placement candidate point included in the display area (a larger area than the display area can be alternatively used).

Although in this Embodiment 1 the explanation is made by assuming that the process of specifying a placement candidate point in the display area is performed, a placement candidate point of a processing target character string can be alternatively specified with a larger area than the display area being defined, as shown in the parentheses of the above-mentioned condition 3.

Because C(1), among the placement candidate points C(1) to C(5) of the character string “GOOD”, exists outside the display area in the case of the example shown in FIG. 5, the placement candidate points of the processing target character string are C(2) to C(5).

A minimum evaluation function value is then set as a maximum (MAX) (step ST16). More specifically, the evaluation function calculator 18 initializes a minimum evaluation function value which will be calculated as below as the maximum. After that, processes between steps ST17 and ST23 are repeatedly performed the number of times corresponding to the number of candidate points (processing candidate points) each of which is a processing target, and the processes for each placement candidate point of the processing target character string is performed.

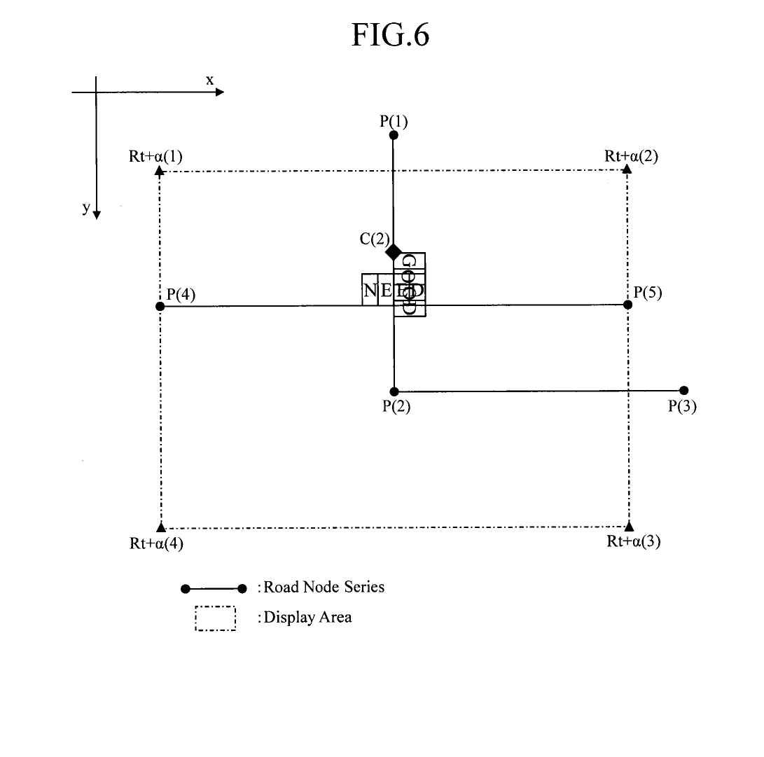

Concretely, placement of the character string is performed first (step ST18). More specifically, the character string placer 17 places the character string which is sent thereto from the processing target character string specifier 14 and which is the processing target from each placement candidate point sent thereto from the processing target candidate point specifier 16 along the road node series included in the character string data sent thereto from the character string data acquiring unit 12. In the case of the above-mentioned example, the character string is first placed from the placement candidate point C(2) along the road node series. This state is shown in FIG. 6. The center coordinates of the characters “G”, “O”, “O”, and “D” are (110, 65), (110, 75), (110, 85), and (110, 95), respectively.

Calculation of an evaluation function is then performed (step ST19). More specifically, the evaluation function calculator 18 calculates an evaluation function. The evaluation function is shown in equation (3). A character string gap function value, a road angle function value, and a display area function value in equation (3) are calculated by a character string gap function calculator 23, a road angle function calculator 24, and a display area function calculator 25, respectively, and are sent to an evaluation function value updater 26. In this case, the character string gap function value shows the degree of overlap between the character string and another character string. Further, the road angle function value shows the angle variation of the road along which the character string is to be placed. Further, the display area function value shows a relationship between the character string and the display area.

The evaluation function value updater 26 sums the character string gap function value, the road angle function value, and the display area function value which are sent respectively from the character string gap function calculator 23, the road angle function calculator 24, and the display area function calculator 25 to finally calculate the evaluation function value F shown by equation (3).

$$F = {\sum }_{n = 1}^{Number of Characters} ln ( Character String Gap Function Value ( {x}_{n} ) ) + ln ( Road Angle Function Value ( {x}_{n} ) ) + ln ( Display Area Function Value ( {x}_{n} ) ) \qquad ( 3 )$$

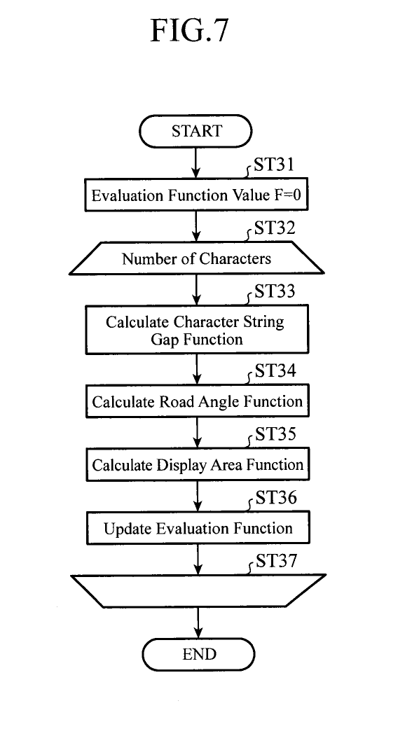

Hereafter, the details of the evaluation function calculation process which is, in step ST19, performed by the evaluation function calculator 18 will be explained with reference to a flow chart shown in FIG. 7.

In the evaluation function calculation process, the evaluation function value F is first initialized to “O” (step ST31). After that, processes between steps ST32 and ST37 are performed repeatedly the number of times corresponding to the number of characters, and the evaluation function is calculated.

Concretely, the character string gap function is calculated first (step ST33). More specifically, the character string gap function calculator 23 calculates the character string gap function value, and sends this value to the evaluation function value updater 26. The character string gap function value can be calculated by using the following equation (4). LabelNum in equation (4) shows the number of character strings which are already placed, and CharacterNumⱼ shows the number of characters included in the j-th character string. Further, K(u, A) shows a Gaussian kernel shown in the following equation (5). xₙ shows the center coordinates of the n-th character of the processing target character string, and x′ⱼᵢ shows the center coordinates of the i-th character in the j-th character string.

$$\begin{matrix}Character String Gap Function Value ( {x}_{n} ) = {\sum }_{j = 1}^{LabelNum} {\sum }_{i = 1}^{{CharacterNum}_{j}} LS \times K ( {x}_{n} - {x}_{jl}^{′} , LC ) & ( 4 ) \\ K ( u , A ) = exp ( - \frac{{u}^{T} {A}^{- 1} u}{2} ) & ( 5 )\end{matrix}$$

Because the character string already placed is only “NEED” in the case of the above-mentioned example, LabelNum is 1. Further, because the number of characters of the character string “NEED” is 4, CharacterNum₁ is 4. Further, because the process is the one on the first character (n=1) of the processing target character string, x₁ is (110, 65). When calculating equation (4) by using these values, the character string gap function value is calculated to be 1.6649.

The character string gap function value in the case of this example has a distribution as shown in FIG. 8, and this distribution has a high value in the vicinity of the character string “NEED” already placed.

The road angle function is then calculated (step ST34). More specifically, the road angle function calculator 24 calculates the road angle function value, and sends this value to the evaluation function value updater 26. The road angle function value can be calculated by using the following equation (6). RoadNum in equation (6) shows the number of nodes, other than the start point and the end point, of the road, and x″ᵢ shows the position of the i-th node. Further, RoadAngle shows the angle variation of the road node series in radian.

$$Road Angle Function Value ( {x}_{n} ) = {\sum }_{i = 1}^{RoadNum} RoadAngle \times RS \times K ( {x}_{n} - {x}_{i}^{″} , RC ) \qquad ( 6 )$$

Because the number of road nodes other than the start point and the end point of the road node series along which the character string “GOOD” is to be placed is 1 in the case of the above-mentioned example, RoadNum is 1 and the node other than the start point and the end point is P(2). Further, because the angle P(1)P(2)P(3) is π/2, RoadAngle is π/2. In this case, RoadAngle is set in such a way as to have a value equal to or less than π. When calculating equation (6) by using these values, the road angle function value is calculated to be 1.3404×e⁻¹⁶.

The road angle function value in the case of this example has a distribution as shown in FIG. 9, and this distribution has a peak at the position of the node P(2) other than the start point and the end point.

The display area function is then calculated (step ST35). More specifically, the display area function calculator 25 calculates the display area function value, and sends this value to the evaluation function value updater 26. The display area function value can be calculated by using the following equation (7). distₙ₁ in equation (7) shows the distance between the center coordinates of the n-th character of the processing target character string and the left side of the display area, and distₙ₂, distₙ₃, and distₙ₄ similarly show the distances between the center coordinates of the n-th character and the upper side, the right side and the lower side of the display area, respectively. Further, K′(A, B) is a sigmoid function shown in the following equation (8), and αₙᵢ is a value varying according to a positional relationship between the position of the character string and the display area, as shown in the following equation (9).

$$\begin{matrix}Display Area Function Value ( {x}_{n} ) = {\sum }_{i = 1}^{4} DS \times {K}^{′} ( {dist}_{ni} , {α}_{ni} ) & ( 7 ) \\ {K}^{′} ( A , B ) = \frac{1}{1 + exp ( - DFS \times A \times B )} & ( 8 ) \\ {α}_{n 1} = \{ \begin{matrix}1 ( When {x}_{n} Exists on the Left of the Left Side ) \\ - 1 ( When {x}_{n} Exists on the Right of the Left Side )\end{matrix} \\ {α}_{n 2} = \{ \begin{matrix}1 ( When {x}_{n} Exists above the Upper Side ) \\ - 1 ( When {x}_{n} Exists below the Upper Side )\end{matrix} \\ {α}_{n 3} = \{ \begin{matrix}1 ( When {x}_{n} Exists on the Right of the Right Side ) \\ - 1 ( When {x}_{n} Exists on the Left of the Right Side )\end{matrix} \\ {α}_{n 4} = \{ \begin{matrix}1 ( When {x}_{n} Exists below the Lower Side ) \\ - 1 ( When {x}_{n} Exists above the Lower Side )\end{matrix} & ( 9 )\end{matrix}$$

Because x₁=(110, 65) exists on the right of the left side, below the upper side, on the left of the right side, and above the lower side in the case of the above-mentioned example, the values αₙ₁ to αₙ₄ are all −1. Further, the distances dist₁₁ to dist₁₄ with the left side, the upper side, the right side, and the lower side have values shown below.

dist₁₁=110

dist₁₂=65

dist₁₃=90

dist₁₄=135

When calculating equation (7) by using these values, 0.0066 is acquired.

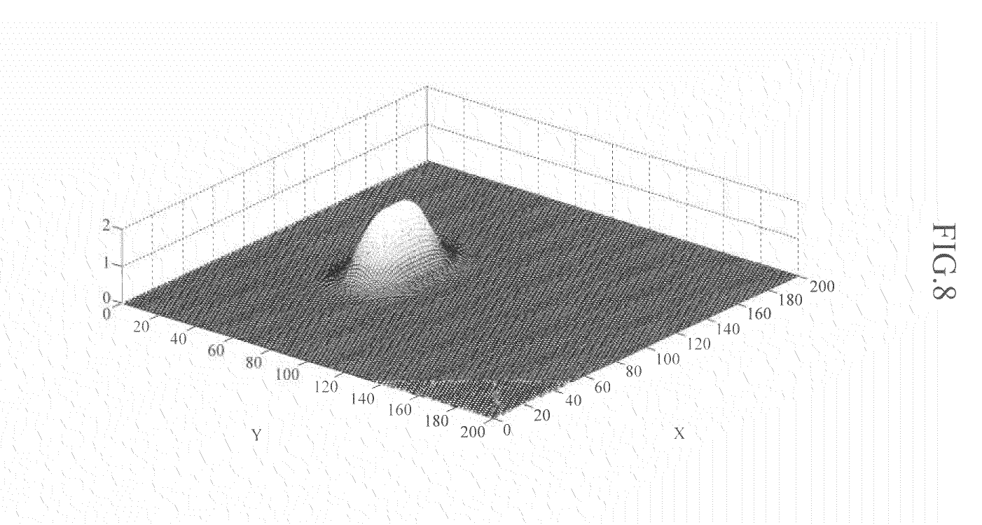

The display area function value in this case has a distribution as shown in FIG. 10, and the distribution has a low value in the inside of the display area and has a high value in the outside of the display area.

An update of the evaluation function is then performed (step ST36). More specifically, the evaluation function value updater 26 calculates the value within the sigma (E) notation of equation (3) by using the character string gap function value sent thereto from the character string gap function calculator 23, the road angle function value sent thereto from the road angle function calculator 24, and the display area function value sent thereto from the display area function calculator 25 to update the evaluation function value F. As a result, the evaluation function value F=F+log(1.6649)+log(1.3404×e⁻¹⁶)+log(0.0066) is acquired, and the evaluation function value F is −13.7257.

These processes are repeated for each character, the evaluation function value F is updated, and the evaluation function value of the character string which is placed from the placement candidate point C(2) is calculated. The evaluation function value calculated at this time is −73.2096.

After that, the sequence returns to the processing shown in the flow chart of FIG. 2, and it is checked whether or not the evaluation function value is a minimum, i.e., whether or not the following inequality: “the minimum evaluation function value>the evaluation function value” is established (step ST20). When it is determined in this step ST20 that the evaluation function value is a minimum, storage of the character string placement is performed (step ST21). More specifically, the minimum evaluation function value storer 19 stores the placement of the character string at that time in the character string placement data storage 22.

An update of the minimum evaluation function value is then performed (step ST22). More specifically, because the evaluation function value is a minimum, the minimum evaluation function value storer 19 updates the evaluation function value stored in the minimum evaluation function value data storage by replacing the evaluation function value with the evaluation function value calculated by the evaluation function calculator 18.

In contrast, when it is determined in above-mentioned step ST20 that the evaluation function value is not a minimum, the processes of steps ST21 and ST22 are skipped.

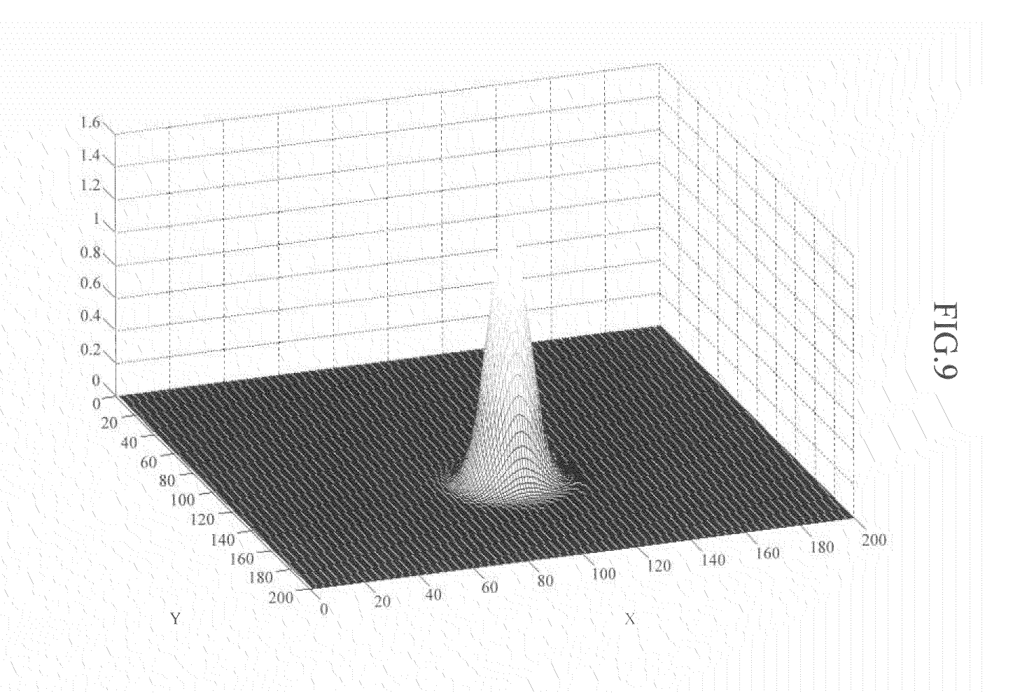

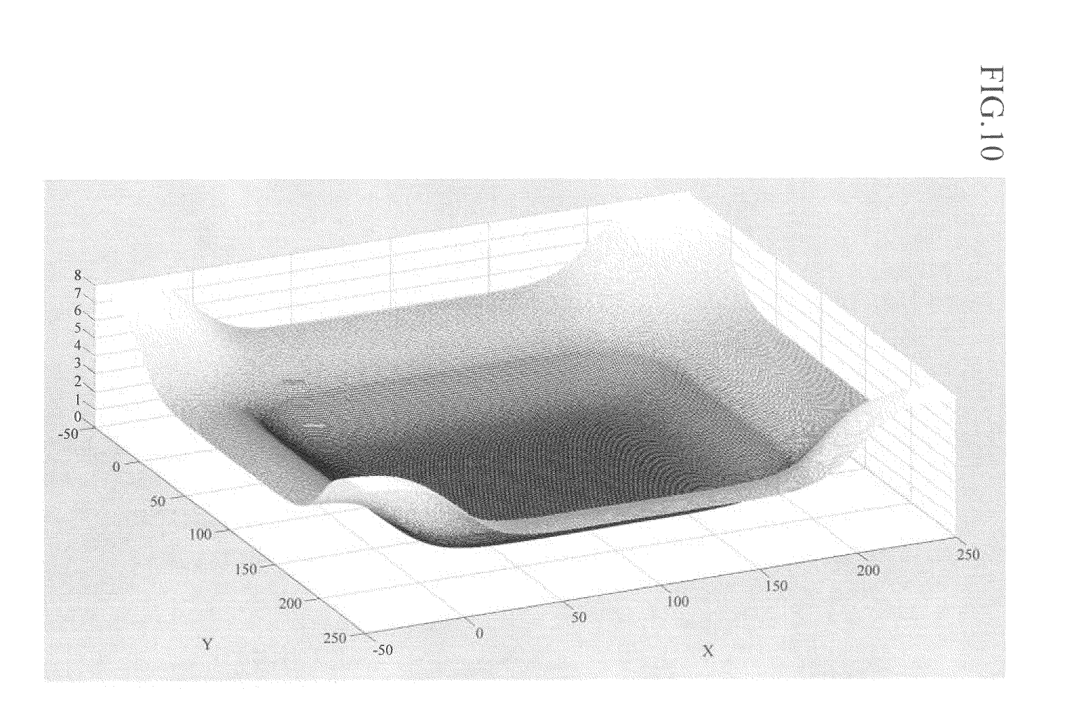

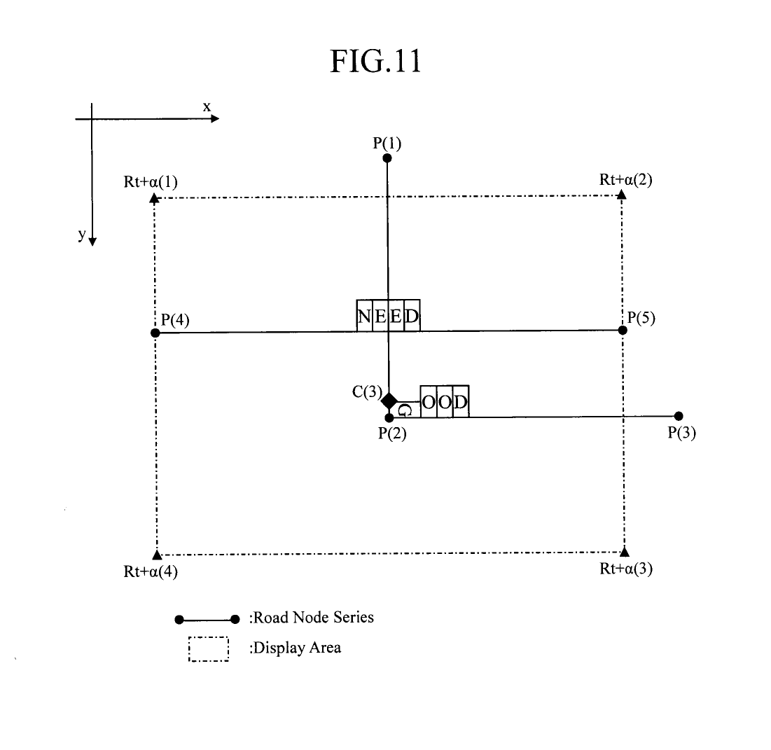

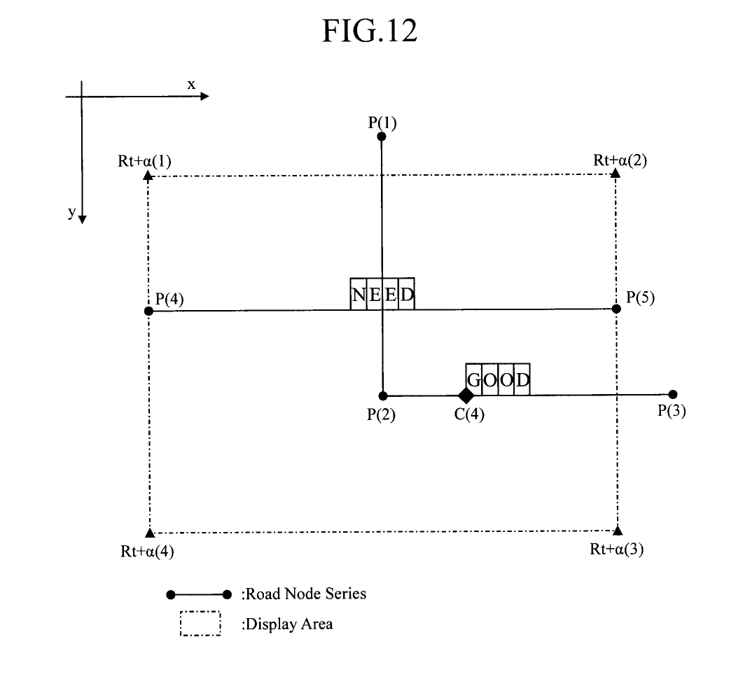

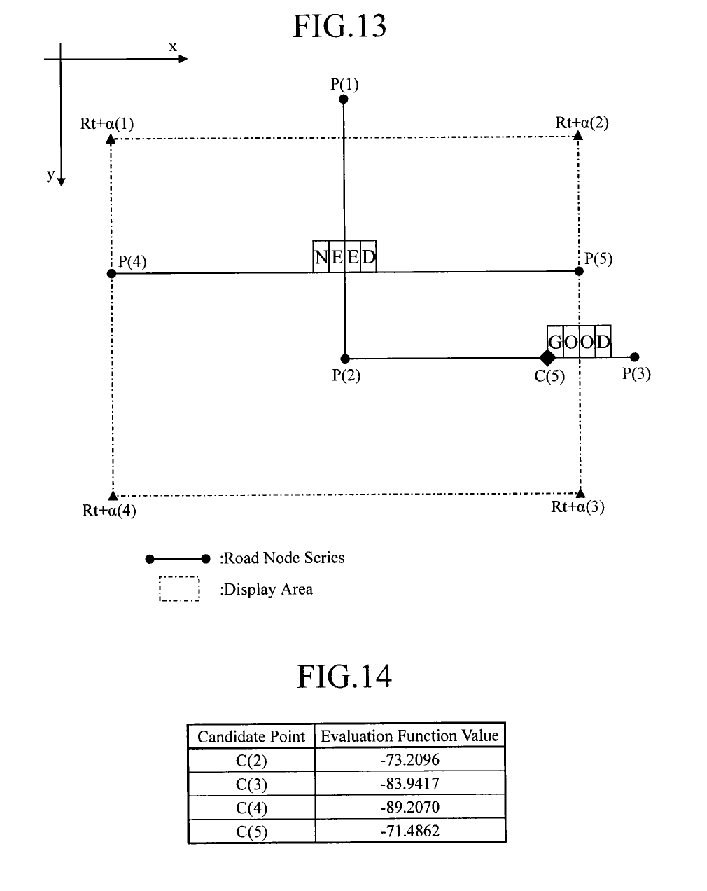

After that, by performing the processing in the same way, the character string placement and drawing device similarly calculates the evaluation function values for the character string which is placed from the placement candidate point C(3) as shown in FIG. 11, the character string which is placed from the placement candidate point C(4) as shown in FIG. 12, and the character string which is placed from the placement candidate point C(5) as shown in FIG. 13 to determine whether or not each of the evaluation function values is a minimum. A correspondence between the character string which is placed from each of the placement candidate points and the evaluation function value is shown in FIG. 14.

After the processes between above-mentioned steps ST13 and ST24 are completed, drawing of the character string is then performed (step ST25). More specifically, because the evaluation function value of the character string which is placed from the placement candidate point C(4) is the smallest, the character string drawing unit 20 reads the character string which is placed from C(4) from the character string placement data storage 12, and draws the character string. After that, the processing is ended.

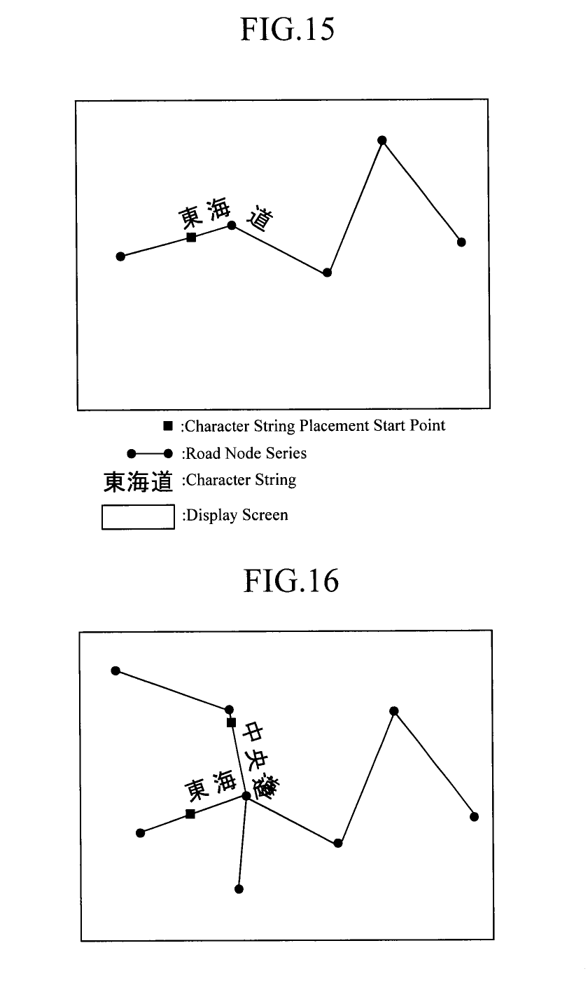

Although the character string placement and drawing device has a function of placing a character string, such as a road name, from a point (character string placement start point) at which the placement of the character string is started along a road line (road node series), as shown in FIG. 15, the character string placement and drawing device has four problems caused by the character string placement start point being not appropriate, as mentioned in the chapter of Background of the Invention. That is, the character string placement and drawing device has the following problems:

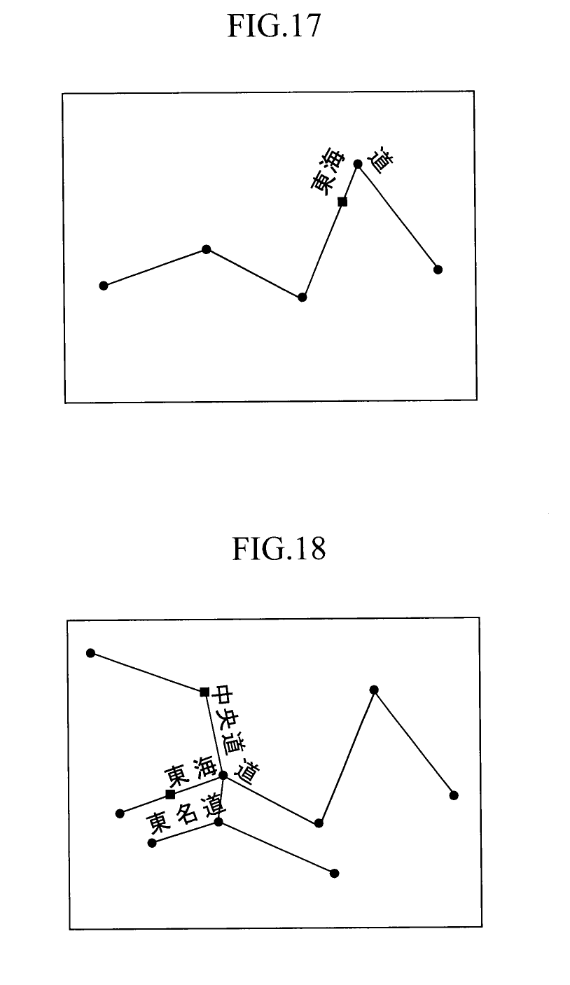

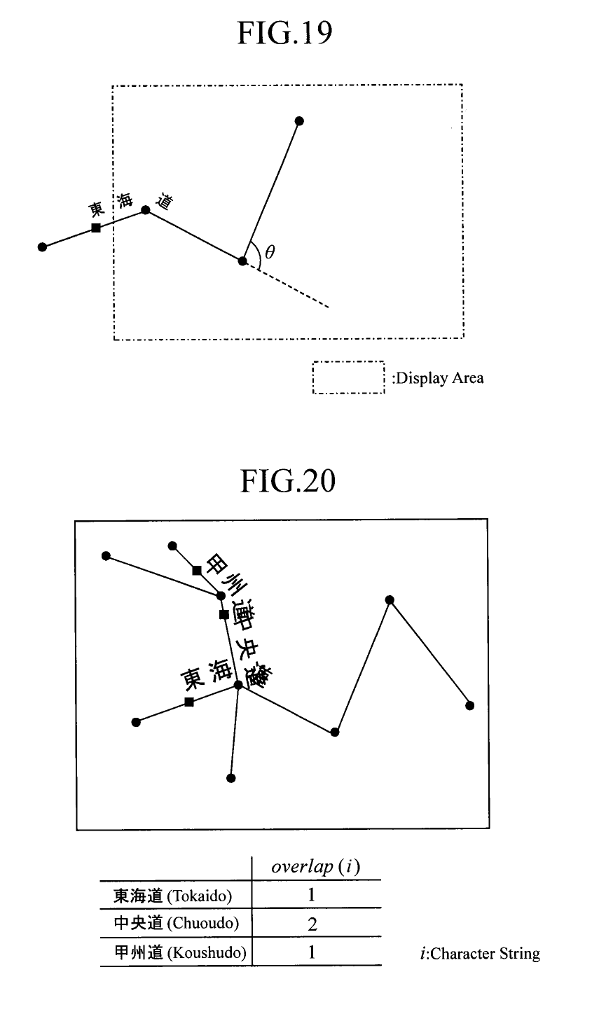

(1) an overlap between character strings as shown in FIG. 16;
(2) a reduction in the readability due to a change of the display angles of characters as shown in FIG. 17;
(3) a reduction in the readability due to the crowding of character strings as shown in FIG. 18
(4) a partial disappearance of a character string due to a change of the display area as shown in FIG. 19.
However, according to the character string placement and drawing device in accordance with above-mentioned Embodiment 1, these problems can be solved.

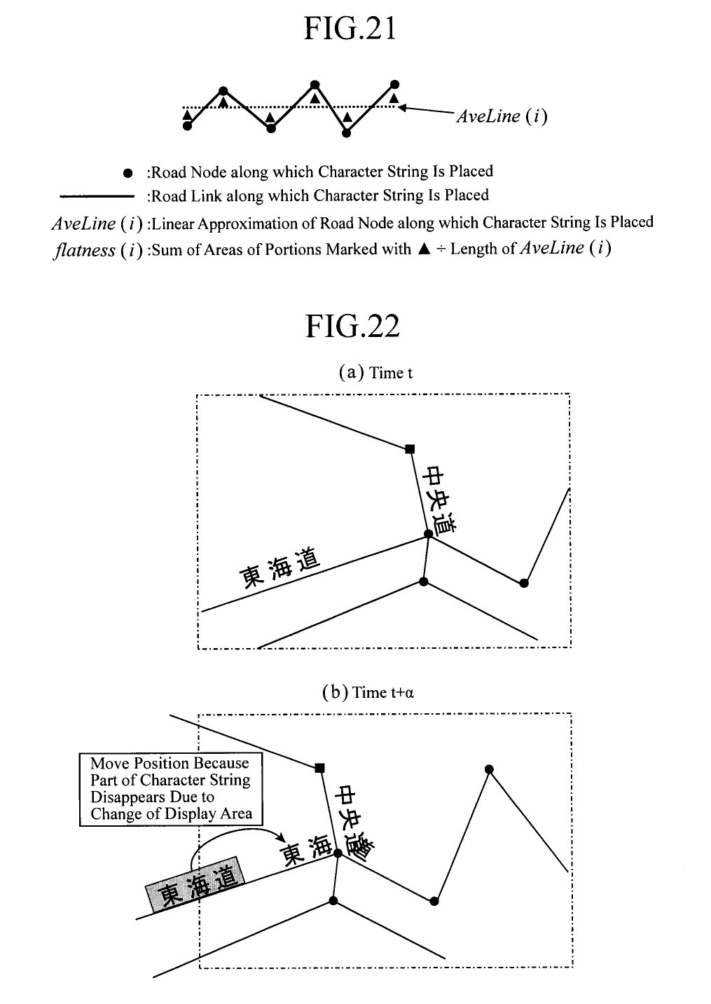

Further, according to the technique disclosed by above-mentioned nonpatent reference 1, by minimizing an evaluation function value f, as shown in equation (10), which consists of a function showing an overlap between character strings as shown in FIG. 20 and a function showing an angle variation as shown in FIG. 21 in a road node series along which a character string is to be placed, an optimal character string placement start point is determined.

$$f = {\sum }_{i}^{String \_ num} {α}_{1} Overlap ( i ) + {α}_{2} flatness ( i ) \qquad ( 10 )$$

α₁ and α₂ in equation (10) are parameters used for adjusting the values of overlap(i) and flatness(i), and String Num shows the number of character strings.

Although the use of this evaluation function f can avoid the problems of (1) an overlap between character strings and (2) a reduction in the readability due to a change of the angle of the road along which a character string is to be placed, the problem of (3) a reduction in the readability due to the crowding of character strings cannot be avoided. However, according to the character string placement and drawing device in accordance with this Embodiment 1, the problem of (3) a reduction in the readability due to the crowding of character strings can also be avoided.

Further, although the technique disclosed by patent reference 1 makes it possible to dynamically change the position of a character string according to a change of the display area in order to solve the problem of (4), the problems (1) to (3) are not taken into consideration. FIG. 22 shows an example of changing the placement position of a character string by using the technique disclosed by patent reference 1. FIG. 22(a) shows the placement of the character string at a time t. Further, FIG. 22(b) shows that a time a has elapsed since the time t, and the display area has changed. According to the change of the display area, the placement position of the character string “ [symbol] (Tokaido)” is changed. FIG. 22(b) shows that because no change of the position in consideration of (1) an overlap between character strings is performed in the technique disclosed by patent reference 1, the character string overlaps with another character string. In contrast with this, according to the character string placement and drawing device in accordance with Embodiment 1, this problem can be avoided.

As previously explained, the character string placement and drawing device in accordance with Embodiment 1 is characterized in that as compared with the character string which has an overlap with the character string “NEED” and which is placed from the placement candidate point C(2), the character string which has a large angle variation of the road and low readability and which is placed from C(3), and the character string which is placed outside the display area and which is placed from the placement candidate point C(5), the evaluation function value of the character string without these problems which is placed from the placement candidate point C(4) is the smallest. When the problems of (1) to (4) shown in the chapter of Background of the Invention do not arise, the evaluation function value becomes small, whereas when either one of the problems of (1) to (4) arises, the evaluation function value becomes large. Therefore, the character string can be placed at an optimal position.

The character string placer 17 can be constructed in such a way as to move a character string to the center of the display area while taking an overlap between character strings and so on into consideration. According to this structure, the number of times that the placement position of a character string is changed can be reduced.

While the invention has been described in its preferred embodiment, it is to be understood that various changes can be made in an arbitrary component according to the embodiment, and an arbitrary component according to the embodiment can be omitted within the scope of the invention.

### INDUSTRIAL APPLICABILITY

Because the character string placement and drawing device according to the present invention can improve the readability of a character string and also position characters at a high speed, the character string placement and drawing device is suitable for use in map display performed by a car navigation system or a portable device.

### EXPLANATIONS OF REFERENCE NUMERALS

11 character string data storage, 12 character string data acquiring unit, 13 display area data storage, 14 processing target character string specifier, 15 candidate point acquiring unit, 16 processing target candidate point specifier, 17 character string placer, 18 evaluation function calculator, 19 minimum evaluation function value storer, 20 character string drawing unit, 21 minimum evaluation function value data storage, 22 character string placement data storage, 23 character string gap function calculator, 24 road angle function calculator, 25 display area function calculator, 26 evaluation function value updater.

1-6. (canceled)

7. A character string placement and drawing device comprising:
a character string placer that places a character string from each of placement candidate points of said character string along a road node series;
an evaluation function calculator that calculates evaluation function values for evaluating readability of said character string from a gap between the character string and another character string which are placed by said character string placer; and
a character string drawing unit that draws said character string by using the evaluation function values calculated by said evaluation function calculator.

8. The character string placement and drawing device according to claim 7, wherein said evaluation function calculator includes a road angle function calculator that calculates a road angle function value for evaluating an angle variation of a road along which said character string is to be placed, and a display area function calculator that calculates a display area function value for evaluating a relationship between said character string and a display area, and an evaluation function value updater that updates each of said evaluation function values by using said road angle function value and said display area function value is disposed.

9. The character string placement and drawing device according to claim 7, wherein an evaluation function value storer that stores said evaluation function values and placements of said character string corresponding to said evaluation function values is disposed between said evaluation function calculator and said character string drawing unit.

10. The character string placement and drawing device according to claim 9, wherein said evaluation function value storer stores a character string gap function value which avoids an overlap between said character string and another character string and improves readability of said character string, stores said road angle function value which avoids placement of the character string along a road which is not flat from among said road angle function values, and also stores said display area function value which avoids placement of said character string outside said display area from among said display area function values.

11. The character string placement and drawing device according to claim 7, wherein a processing target character string specifier specifies said character string which is a processing target from a character string data storage that stores character string data, and also specifies a position where said character string is to be placed is disposed.

12. The character string placement and drawing device according to claim 11, wherein said character string data include a number of character strings, a road node series along which said character strings is to be placed, and placement candidate points of said character strings.

13. The character string placement and drawing device according to claim 8, wherein a processing target candidate point specifier that selects said placement candidate points included in said display area as processing targets is disposed.

14. The character string placement and drawing device according to claim 7, wherein said character string placer places said character string by moving said character string to a center of a display area.
